(19) United States
(12) Patent Application Publication
(10) Pub. No.: US 2004/0118883 A1
(43) Pub. Date: Jun. 24, 2004

(54) Baby belt

(76) Inventors: Stuart Fife, Nashville, IN (US); Stephen Miller, Midway, GA (US)

Correspondence Address: STUART FIFE, 664 HIGHLAND DRIVE, NASHVILLE, IN, 47448, US

(21) Appl. No.: 10/328,385

(22) Filed: Dec. 24, 2002

(51) Int. Cl. A61G 1/00; A45C 1/04; A45F 3/00; F41C 33/02; F42B 39/02

(52) U.S. Cl. 224/159; 224/663

(57) ABSTRACT

The baby belt is a carrying device for small infants and babies. It is made up from a supportive block attached to a strong belt that goes around the carriers' waist. The infant or baby-sits astride the block and the carrier uses their arm to keep the baby on the block. This allows the carrier to see the baby at all times, pick up or put down the infant very quickly, use the carrier for short or long duration and protects the carriers' lower back from stress and fatigue allowing them to maintain normal anatomical alignment. This belt would be suitable for household use as well as outside use and would also be very comfortable in hot or cold climates. It also allows the baby or infant to be in a close ‘natural ’ position to the carrier and allow for nurturing communications and close bonding. It positions the infant or baby where most parents would naturally hold their child but protects them from fatigue stresses.

### BACKGROUND OF THE INVENTION—BABY BELT

This invention relates to the field of baby carriers, specifically when the infant is carried in direct contact with the carrier. Existing carriers are not designed to support and protect the carriers back from stress other than distributing the weight of the infant. They also do not allow for rapid positioning of the infant in and out of the carrier.

### BRIEF SUMMARY OF THE INVENTION

This invention was the result of the collaboration of an orthopedic physical therapist and certified orthotist looking at the problems of transporting babies and small infants. Current carriers fall basically into two groups, the sling type, and the ‘back pack type’. The sling type supports can stress the carrier's neck and are difficult to use with older infants. They are difficult to quickly get infants in and out especially if that is quickly repeated. They do have the advantage of allowing free hands for the carrier. The back pack type of carrier either an anterior or posterior carrier distributes weight but can still lead to the carrier leaning either forward or backward to balance the weight. They are more cumbersome and again take more time for the infant to be placed in them or taken out of them.

Although the ‘baby belt’ was not designed exclusively for females, analysis of a mother's natural positions inspired the current design. A mother will try to support her baby on the iliac crest of her pelvis, attempting to allow the weight of the child to be distributed through the pelvis to the feet. She attempts, but is not successful, to reduce the load to her arms to reduce fatigue. This is why the babies are constantly transferred from one hip to another. Another tactic is to stick the pelvis out further but this can increase stress to the lower back.

During pregnancy females the hormone relaxin is released that has the effect of softening ligaments. Added to that many females experience low back pain during pregnancy and the protective function of the abdominal muscles is significantly reduced. Cumulative trauma to the back is often the cause of back pain and the constant picking up, carry and putting down of the infant takes its' toll.

The ‘baby belt’ addresses these issues

It forms an extension of the carriers' pelvis without compromising the anatomical alignment of the hip, pelvis or low back,

It supports the low back during carrying and lifting,

It encourages the use of correct body mechanics,

It is easy to put on and the infant is very easily moved on and off the belt, which is increasingly important as the infant slowly gains independence,

It minimizes the load to the upper extremities,

It is equally useful around the house, outside and in hot or cold weather.

It can be used longer than the other devices in terms of the infants' age.

It loads the pelvis directly transferring weight to the feet and saving the upper body and low back of stress,

It allows for the normal anatomical position of the body during use without the carrier having to stick out the pelvis

It supports the low back preventing fatigue type stress

### DESCRIPTIONS OF DRAWINGS

FIG. 1 Shows the entire belt and illustrates the slight thickening of the belt for the lower back and for the abdomen.

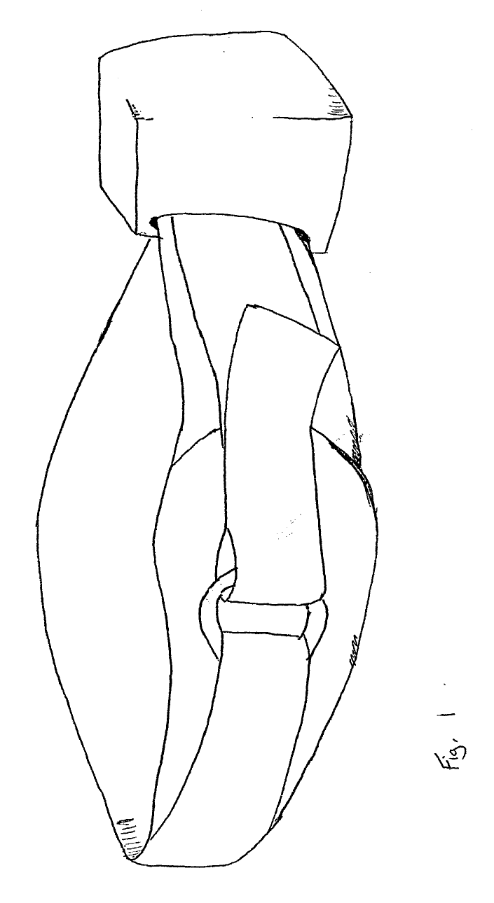

FIG. 2 shows the fastening system, which is a single buckle with a Velcro fastening pull through, and stick. This allows sufficient tightening of the belt to support the pelvis.

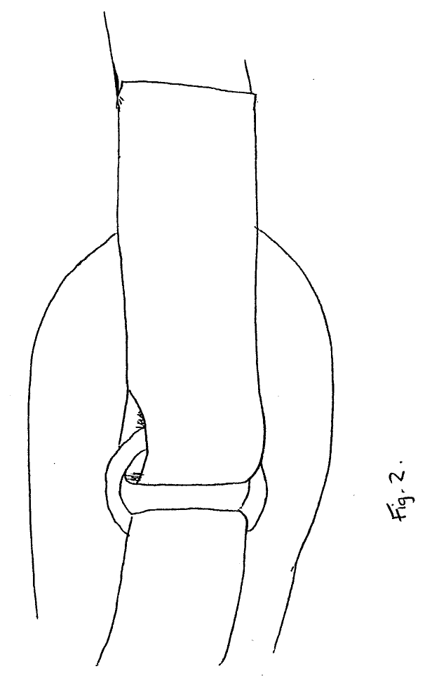

FIG. 3. Shows the support block and emphasizes the slope of the top of the block towards the carrier.

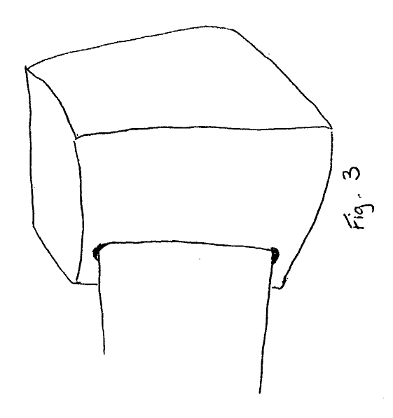

FIG. 4. Shows the internal support of the block. This will be toughened plastic in the shape of and L′ and the foam with a hardened shell will be formed around it.

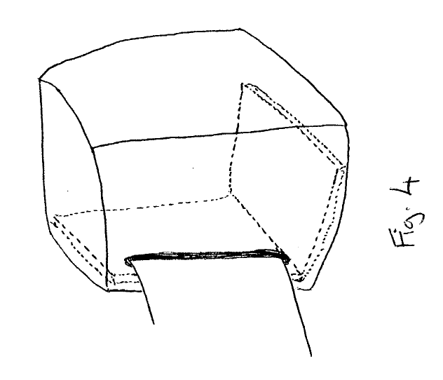

FIG. 5. Shows several views of the block illustrating the wedge from top to bottom, and the slope on the top, from outside to inside. This creates the optimum surface for the infant to sit on

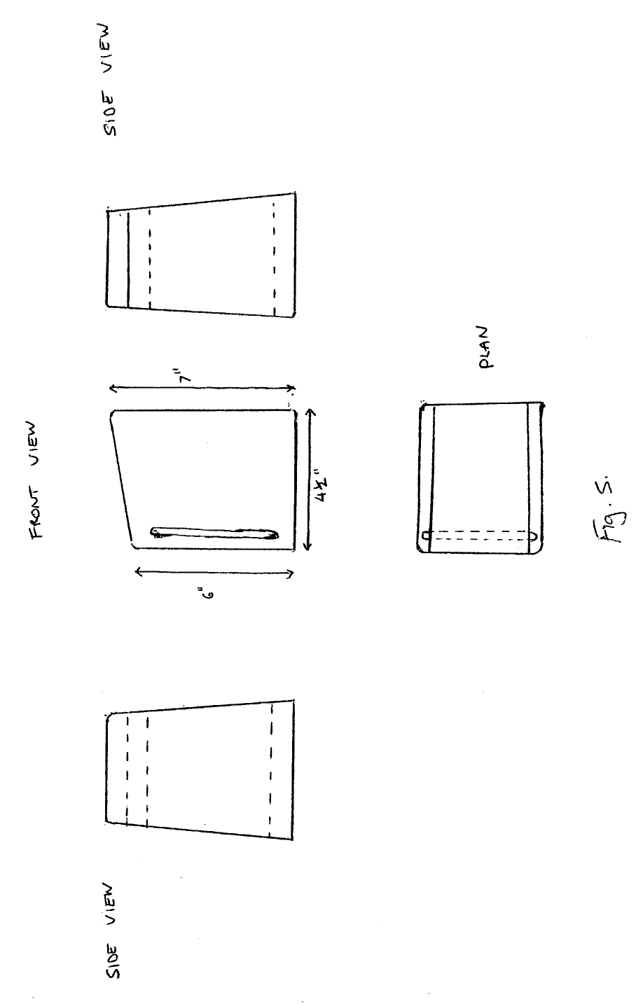

### DETAILED DESCRIPTION OF THE INVENTION

The belt is made of two parts, the belt part and the block for the baby to sit on. The belt has a simple Velcro fastening system with a single buckle to allow the belt to be fastened back on itself The belt also is thicker in the front and backs to better support the low back and the abdomen. The belt is made in a two part design with an underbelt made from comfortable neoprene that flexes with movement and prevents slipping. The over belt is attached to the block and is made from a sturdy nylon providing a sturdy lumbar support.

The block is made from a high density polyfoam with a polypropylene support within and coated with a seamless vinyl. The overbelt goes through the slit in the block for complete attachment.

Operation

The user of the belt simply puts the belt around their waist and fastens the belt tight with the block positioned comfortably on the anterior lateral part of the pelvis. The user then simply puts the infant on the block facing the carrier and with the babys' legs astride the block. The user then keeps their arm around the infant to secure the infant from falling back. The arm will not be holding the weight of the infant. The baby can then be very easily put on or off the block and can be carried for short or long periods of time.

1. What we claim as our invention is a baby belt for carrying infants and babies and comprises;
a) a belt going around the carriers waist that supports the low back and allows the weight of the infant or baby to be carried in the pelvis and distributed to the feet: The belt has a simple Velcro fastening system.
b) a block attached to the belt to support the babies or infants weight by allowing the baby or infant to sit astride it. This enables the weight of the baby to be carried in the pelvis and lower extremities and unload the upper extremities and lower back. This block can slide around the belt to allow for precise adjustment by the wearer.
